(19) United States
(12) Patent Application Publication
(10) Pub. No.: US 2017/0362477 A1
(43) Pub. Date: Dec. 21, 2017

(54) CONSTRUCTION ADHESIVE COMPOSITIONS

(71) Applicant: UNITED STATES GYPSUM COMPANY, Chicago, IL (US)

(72) Inventors: Renee L. Weinberger, Waukegan, IL (US); Rafael Bury, Wheeling, IL (US)

(73) Assignee: UNITED STATES GYPSUM COMPANY, Chicago, IL (US)

(21) Appl. No.: 15/609,995

(22) Filed: May 31, 2017

Related U.S. Application Data
(60) Provisional application No. 62/351,376, filed on Jun. 17, 2016.

(51) Int. Cl. C09J 157/06; C04B 41/48; C09J 11/04; B32B 37/12; C09J 5/00; C08K 3/34; C08K 3/26

(52) U.S. Cl. CPC C09J 157/06; B32B 37/12; C04B 41/483; C09J 5/00; C09J 11/04; B32B 2607/00; C08K 3/26; C08K 3/346; C09J 2400/10; C09J 2433/00; C08K 2003/265

(57) ABSTRACT

A construction adhesive composition comprises between about 10 weight percent (wt. %) and about 30 wt. % of a vinyl acrylic latex, between about 30 wt. % and about 65 wt. % of calcium carbonate, and a surfactant.

### CROSS REFERENCE TO RELATED APPLICATION

This application claims the benefit under 35 U.S.C. §119(e) of U.S. provisional patent application Ser. No. 62/351,376, filed Jun. 17, 2016, the entire disclosure of which is incorporated herein by reference, is hereby claimed.

### FIELD OF INVENTION

The present disclosure is directed to construction adhesive compositions, more particularly, to construction adhesive compositions suitable for adhering wallboard to studs and structures comprising cementitious materials such as concrete walls and masonry structures and for adhering ceiling tiles to existing ceiling structures.

### BACKGROUND OF INVENTION

Adhesive compositions are used for a variety of purposes. Certain adhesive compositions are intended for laminating wallboard to wood framing. A representative adhesive composition for laminating wallboard to wood framing comprises polyvinyl acetate and water. Unfortunately, such adhesive compositions generally are not cost-effective. Joint compound (which can comprise water, calcium carbonate, calcium sulfate, expanded perlite, ethylene-vinyl acetate polymer, and/or attapulgite) is often used to laminate pieces of wallboard together and for laminating drywall to wood framing and to structures comprising cementitious materials such as concrete walls and masonry structures. However, the wallboard often tends to sag/slide after application. Further, the joint compound can often take a long time, up to several weeks, to fully dry and provide a bond of sufficient mechanical strength between concrete or masonry walls and the wallboard.

### DETAILED DESCRIPTION

The disclosure provides construction adhesive compositions formulated to attach wallboard, particularly gypsum wallboard, to studs and structures comprising cementitious materials including but not limited to concrete walls and masonry structures. The construction adhesive compositions may also be used to adhere ceiling tiles to an existing ceiling surface. The construction adhesive compositions according to the disclosure may have a rheology profile that advantageously enables application such that the adhesive composition need not be applied by a conventional caulk gun. For example, the construction adhesive compositions according to the disclosure may be applied using a grout bag. As a result of the rheology profile allowing for flow through a grout bag, the construction adhesive compositions according to the disclosure are faster and easier to apply than other similar products on the market, such that adhering wallboards to studs and cementitious structures is simplified and easier to accomplish. Consequently, for example, concrete and/or masonry walls can be finished faster and gypsum wallboard can be installed more quickly. Similarly installing wallboard on metal or wood studs can be accomplished more readily and existing ceilings can be finished with ceiling tiles more efficiently. In addition, the construction adhesive compositions according to the disclosure are cost effective and provide an adhesive bond with good mechanical strength when used to adhere wallboard to studs and structures containing cementitious materials and ceiling tiles to existing ceiling structures, particularly relative to construction adhesives intended for adhesion of wallboard to wood framing. Finally, the dry time needed for the adhesive compositions according to the disclosure to provide bonds of good mechanical strength between structures comprising cementitious materials and the wallboard are significantly improved (at least relative to joint compound). In one example, which was a hot/humid environment, it took about seven full days for joint compound to cure and provide a bond of good mechanical strength whereas it took less than 24 hours for the adhesive composition of the disclosure to provide a bond of good mechanical strength.

The disclosed construction adhesive compositions have been formulated to adhere wallboard, particularly gypsum wallboard, to studs and structures comprising cementitious materials including but not limited to concrete walls and masonry structures and are surprisingly effective in terms of providing bonds of good mechanical strength even in challenging conditions presented by hot and humid environments. In this respect, the inventors surprisingly found that vinyl acrylic latex provides significant performance advantages to the disclosed construction adhesive compositions relative to other latexes. Specifically, the inventors determined that other latexes such as styrene acrylic latex and vinyl acetate latex, which may be considered to be similarly performing latexes in other adhesive applications, when included in otherwise comparable compositions, do not provide effective construction adhesive compositions for laminating wallboard to concrete or masonry. For example, relative to the construction adhesive compositions according to the disclosure, compositions comprising styrene acrylic latex or vinyl acetate latex often provide adhesive bonds of poor mechanical strength between structures comprising cementitious materials and the wallboard and/or did not achieve a desirable rheology profile at a suitable pigment to binder ratio.

In one embodiment, the disclosure provides a construction adhesive composition comprising between about 10 weight percent (wt. %) and about 30 wt. % of a vinyl acrylic latex, between about 30 wt. % and about 65 wt. % of calcium sulfate dihydrate, calcium carbonate, calcium magnesium carbonate, or a mixture thereof, and a surfactant.

In another embodiment, the disclosure provides a method of adhering wallboard to a cementitious structure comprising providing a wallboard, providing a concrete or masonry substrate, applying a coating of the construction adhesive composition according to the disclosure to either the wallboard or the concrete substrate, and adhering the wallboard to the concrete or masonry substrate.

In a further embodiment, the disclosure provides a method of adhering wallboard to first and second studs comprising providing first and second studs, applying a coating of the construction adhesive composition according to the disclosure to either the wallboard or the first and second studs, and adhering the wallboard to the first and second studs.

In a further embodiment, the disclosure provides a method of adhering ceiling tiles to an existing ceiling structure comprising applying a coating of the construction adhesive composition according to the disclosure to either the ceiling tiles or the existing ceiling structure, and adhering the ceiling tiles to the existing ceiling structure.

The vinyl acrylic latex may be present in the construction adhesive compositions according to the disclosure in an amount between about 10 weight percent (wt. %) and about 30 wt. %, between about 15 wt. % and about 30 wt. %, and/or between 20 wt. % and about 25 wt. %. The vinyl acrylic latex may be a “self-thickening” vinyl acrylic latex. A self-thickening vinyl acrylic latex can self-cross-link at pH values above about 7.5, for example, at pH values between about 7.5 and about 10.5, and as a result, can increase the viscosity of the construction adhesive composition while also minimizing the use of additional, added thickeners. Of course, a non-self-thickening vinyl acrylic latex may also be used, optionally in combination with a separate cross-linking agent and/or other distinct thickeners. Representative vinyl acrylic latexes that may be used include but are not limited to RHOPLEX™ A920 (The Dow Chemical Company), ACRYLTAC® SP400 (H.B. Fuller), and Unibond VA-230 (Unichem Inc.).

The calcium sulfate dihydrate, calcium carbonate and/or calcium magnesium carbonate (also referred to as dolomite) may be present in the construction adhesive compositions according to the disclosure in an amount between about 30 wt. % and about 65 wt. %, between about 35 wt. % and about 60, between about 40 wt. % and about 55 wt. %, and/or between about 40 wt. % and about 50 wt. %. Generally, calcium carbonate is used alone or as the predominant component in any combination with calcium sulfate dihydrate and/or calcium magnesium carbonate because of its greater availability. The density of the calcium sulfate dihydrate, calcium carbonate and/or calcium magnesium carbonate materials used in the construction adhesive compositions generally ranges between 2.2 grams per cubic centimeter (g/cm³) and 2.9 g/cm³.

Surfactants are included in the construction adhesive compositions according to the disclosure in amounts sufficient to stabilize the calcium sulfate dihydrate, calcium carbonate and/or calcium magnesium carbonate such that the calcium sulfate dihydrate calcium carbonate and/or calcium magnesium carbonate does not aggregate. A number of surfactants may be used for this purpose. Generally, one or more surfactants is present in the construction adhesive compositions according to the disclosure in an amount between about 0.50 wt. % and about 2 wt. %, between about 0.60 wt. % and about 1.60 wt. %, and/or between about 0.75 wt. % and about 1.50 wt. %. Representative surfactants include but are not limited to non-ionic surfactants having a HLB value greater than about 11 including but not limited to octylphenol ethoxylates and nonylphenol ethoxylates. Useful surfactants having HLB values greater than about 11 are marketed under the TRITON™ trade name (The Dow Chemical Company). As mentioned above, other surfactants may also be used.

In some embodiments, the construction adhesive compositions according to the disclosure further comprise a dispersant to adequately disperse the calcium sulfate dihydrate, calcium carbonate and/or calcium magnesium carbonate. The dispersant may comprise a hydrophilic copolymer salt and/or a polyacid salt. Useful dispersants are marketed under the TAMOL® trade name (The Dow Chemical Company). Hydrophilic copolymer salts such as TAMOL® 1254 may be used in the construction adhesive compositions according to the disclosure. Tripolyphosphate salts and tetrapotassium pyrophosphate can also be used to disperse the calcium sulfate dihydrate, calcium carbonate and/or calcium magnesium carbonate in the construction adhesive compositions according to the disclosure. A suitable tripolyphosphate salt is potassium tripolyphosphate.

In some embodiments, the construction adhesive compositions according to the disclosure are substantially free of added thickeners. Minimizing the use of added thickeners can positively affect (i.e., reduce) the drying time of the disclosed construction adhesive compositions in actual use. In the context of this disclosure, “substantially free of added thickeners” means that the construction adhesive compositions according to the disclosure contain less than about 3 wt. % of thickeners, based on the total weight of the composition. For example, the construction adhesive compositions according to the disclosure may contain less than about 2 wt. % or less than about 1 wt. % of added thickeners. When included, for example, the thickener may be a gelling grade clay and included in the construction adhesive compositions according to the disclosure in an amount between 0 wt. % and 3 wt. %, or between 1.0 wt. % and 2.0 wt. %. The gelling grade clay may be attapulgite, smectite, bentonite, kaolite, sepiolite, or a combination thereof. In some embodiments, the construction adhesive compositions according to the disclosure are free of polysaccharide thickeners such as starch and xanthan gum, i.e., no added polysaccharide thickener is included.

As mentioned above, the pH of the composition may be above about 7.5 in order to help induce cross-linking of a self-thickening vinyl acrylic latex in the construction adhesive compositions according to the disclosure. Generally, the construction adhesive compositions according to the disclosure have a pH between about 7.5 and about 10.5, or between about 8 and about 9. Any number of pH adjusting components may be added to make the disclosed construction adhesive compositions basic as described above including but not limited to ammonia, sodium hydroxide, tri-ethylamine (TEA), and 2-amino-2-methyl-1 propanol (AMP).

In general, it has been found that a pigment (typically, in the construction adhesive compositions according to the disclosure, the pigment comprises or substantially consists of calcium sulfate dihydrate, calcium carbonate and/or calcium magnesium carbonate) to binder (typically, in the construction adhesive compositions according to the disclosure, the binder comprises or substantially consists of the polyvinyl acrylic latex) ratio between about 2 and about 5, between about 2.5 and about 4.5, and/or between about 2.8 and about 4 provides faster drying, advantageous wet and dry bonding strength, and a desirable rheology profile in the construction adhesive compositions according to the disclosure. In this respect, the disclosed construction adhesive compositions generally have a viscosity between 400 Brabender Units (BU) and 12000 BU (between 10680 cps and 320,400 cps) and/or between about 500 BU and about 1000 BU (between about 13,350 cps and 26,700 cps) as measured by a Brookfield viscometer operated at 50 rpm using a paste spindle at 25° C. Such a viscosity is useful in that it facilitates application of the disclosed construction adhesive compositions using a grout bag, as discussed above.

With respect to wet bonding strength, the construction adhesive compositions according to the disclosure advantageously provide advantageous wet tensile strengths greater than 10 pounds per square inch (“psi”) (corresponding to 68,948 pascals), for example, between 10 psi and 25 psi (between 68,948 pascals and 172,369 pascals), between 15 psi and 25 psi (between 103,421 pascals and 172,369 pascals), and/or between 18 psi and 25 psi (between 124,106 pascals and 172,369 pascals). In comparison, standard adhesive compositions typically provide wet tensile strengths less than 10 psi, typically between 6 psi and 10 psi. Because of the advantageous wet tensile strengths provided by the construction adhesive compositions according to the disclosure, wallboard can be adhered to studs or a cementitious structure such as concrete walls or masonry structures without the need for mechanical bracing.

Pigment volume concentration (“PVC”) provides a measurement of the volume of pigment to the volume of solid binder. In the construction adhesive compositions according to the disclosure, the PVC ranges between about 46.6% and about 68.3%, between about 52.4% and about 65.9%, and/or between about 54.9% and about 63.3%.

The construction adhesive compositions according to the disclosure may optionally contain other additives including but not limited to wetting agents, biocides, fungicides, and other suitable additives as long as the added component(s) do not substantially adversely affect the stabilization of the calcium carbonate and/or calcium magnesium carbonate, the rheology profile, and/or the drying time.

In various embodiments, the construction adhesive composition may contain from about 15 wt. % to about 55 wt. %, about 25 wt. % to about 45 wt. %, and/or about 30 wt. % to about 40 wt. % of water. It is generally preferred, however, to keep the solids level as high as possible in the construction adhesive compositions according to the disclosure.

The construction adhesive compositions according to the disclosure may be applied to a substrate surface via any application method including but not limited to a trowel, a grout bag, and the like. Substrates suitable for adhering to one another include but are not limited to structures comprising cementitious materials such as concrete walls and masonry structures and inorganic wallboard panels such as gypsum wallboard formulated for interior applications, metal or wooden studs to inorganic wallboard panels such as gypsum wallboard formulated for interior applications, and existing ceiling structures to ceiling tiles. Suitable wallboard panels are available under the FIBEROCK® and SHEETROCK® trade names (United States Gypsum Company). Of course, the construction adhesive compositions according to the disclosure may also be applied to other substrate surfaces. Most typically, the construction adhesive compositions according to the disclosure are applied to studs or a structure comprising cementitious materials such as concrete walls and masonry using a grout bag to apply beads of the construction adhesive compositions to the studs or the structure comprising cementitious materials and then the wallboard is adhered to the studs or the structure comprising cementitious materials over the beads. Advantageously, mechanical bracing or other devices to maintain the wallboards in place when the mechanical bond is forming are typically not needed to adhere the wallboard to the studs or structure comprising cementitious materials. Of course, bracing can be used as needed, particularly when ceiling tiles are adhered to an existing ceiling surface so as to form a ceiling with desired decorative or acoustical properties, but typically, bracing is advantageously not needed to adhere wallboard to studs or a cementitious structure as previously described.

As used herein any reference to “ one embodiment” or “ an embodiment” means that a particular element, feature, structure, or characteristic described in connection with the embodiment is included in at least one embodiment. The appearances of the phrase “ in one embodiment” in various places in the specification are not necessarily all referring to the same embodiment.

In addition, uses of “a” or “ an” are employed to describe elements and components of the embodiments described herein. This is done merely for convenience and to give a general sense of the description. This description, and the claims that follow, should be read to include one or at least one, and the singular also includes the plural unless it is clear that it is meant otherwise.

Although the foregoing text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

### EXAMPLE 1

A construction adhesive composition according to the disclosure was prepared. First, a vinyl acrylic latex, a dispersant, and a surfactant were mixed using a mechanical mixer. A biocide was added to the mixture and the mixture was again mixed. Then, calcium carbonate and a gelling clay were added to the mixture and the mixture was again mixed. Finally, a pH adjusting agent and water were added to mixture and the mixture was again mixed. The components were combined in amounts shown in Table 1 and the composition had a viscosity as reported therein.

TABLE 1

| Raw Material | Description | qty (kg) |
|---|---|---|
| RHOPLEX ™ A920 | Vinyl acrylic latex | 89 |
| (The Dow Chemical Company) | (62 weight % solids) | |
| TAMOL ™ 1254 | Dispersant | 0.30 |
| (The Dow Chemical Company) | | |
| TRITON X-405 (The Dow | Surfactant | 2.45 |
| Chemical Company) | | |
| MERGAL ® 174 II (Troy | Biocide | 0.5 |
| Chemical Corporation) | | |
| OMYACARB ® 15-SJ | Calcium Carbonate | 115 |
| (Omya AG) | | |
| MIN-U-GEL (ActiveMinerals | Attapulgite Clay | 4.50 |
| International, LLC) | | |
| AMP-95 (ANGUS | pH adjuster | 1.30 |
| Chemical Company) | | |
| Water | | 36 |
| Total | | 250 |
| Viscosity (50 rpm for 30 sec) | | 500-1000 BU |
| Density | | 1.3 g/cc |

The construction adhesive composition was successfully used to adhere gypsum wallboard panels to concrete walls by using a grout bag to apply beads of the construction adhesive composition to a concrete. Wallboard was then adhered to the concrete wall over the beads. While mechanical bracing was used to maintain the wallboards in place as the mechanical bond was forming between the concrete wall and the gypsum wallboard, a bond of sufficient mechanical strength between the concrete wall and the wallboard was formed within 16 hours.

1. A construction adhesive composition comprising:
between about 10 weight percent (wt. %) and about 30 wt. % of a vinyl acrylic latex;
between about 30 wt. % and about 65 wt. % of calcium carbonate, calcium magnesium carbonate, or a mixture of calcium carbonate and calcium magnesium carbonate; and,
a surfactant,
wherein the construction adhesive composition has a pH between about 7.5 and about 10.5, and wherein the construction adhesive composition has a viscosity between 400 Brabender Units (BU) and 12000 BU (between 10680 cps and 320,400 cps) as measured by a Brookfield viscometer operated at 50 rpm.

2. The construction adhesive composition according to claim 1 comprising the vinyl acrylic latex in an amount between about 15 wt. % and about 30 wt. %, or between about 20 wt. % and about 25 wt. %.

3. The construction adhesive composition according to claim 1 comprising calcium carbonate, calcium magnesium carbonate, or a mixture of calcium carbonate and calcium magnesium carbonate in an amount between about 35 wt. % and about 60 wt. %.

4. The construction adhesive composition according to claim 1 comprising between about 0.50 wt. % and about 2 wt. %, between of the surfactant.

5. The construction adhesive composition according to claim 1 further comprising a dispersant.

6. The construction adhesive composition according to claim 1, wherein the construction adhesive composition is substantially free of added thickeners.

7. The construction adhesive composition according to claim 1, further comprising a gelling grade clay in an amount between 0 wt. % and 3 wt. %.

8. The construction adhesive composition according to claim 7, wherein the gelling grade clay comprises attapulgite, smectite, bentonite, kaolite, sepiolite, or a combination thereof.

9. The construction adhesive composition according to claim 1, wherein the construction adhesive composition is free of cellulosic thickeners.

10. The construction adhesive composition according to claim 1, wherein the construction adhesive composition has a pH between about 8 and about 9.

11. The construction adhesive composition according to claim 1, wherein the construction adhesive composition has a pigment to binder ratio between about 2 and about 5.

12. The construction adhesive composition according to claim 1, wherein the construction adhesive composition has a viscosity between about 500 BU and about 1000 BU (between about 13,350 cps and 26,700 cps) as measured by a Brookfield viscometer operated at 50 rpm.

13. The construction adhesive composition according to claim 1, wherein the vinyl acrylic latex is a self-thickening vinyl acrylic latex.

14. A method of adhering wallboard to a cementitious structure comprising:
providing a wallboard;
providing a concrete or masonry substrate;
applying a coating of the construction adhesive composition according to claim 1 to either the wallboard or the concrete substrate; and,
adhering the wallboard to the concrete or masonry substrate.

15. (canceled)
